(19) United States
(12) Patent Application Publication
(10) Pub. No.: US 2023/0201064 A1
(43) Pub. Date: Jun. 29, 2023

(54) NOVEL STRUCTURAL INVERSION TABLE

(71) Applicant: YONGKANG HAODUO FITNESS EQUIPMENT CO., LTD, Yongkang (CN)

(72) Inventor: LI LI, YONGKANG (CN)

(21) Appl. No.: 17/673,832

(22) Filed: Feb. 17, 2022

(30) Foreign Application Priority Data
Dec. 27, 2021 (CN) 202123319163.0

(51) Int. Cl. A61H 1/02

(52) U.S. Cl. CPC A61H 1/0222; A61H 2201/1607; A61H 2201/1626; A61H 2201/0134

(57) ABSTRACT

A novel structural inversion table includes a body including a back plate, a headrest and a tripod rotationally connected with a cross brace at middle. Air holes are penetrated through the back plate. Two T-shaped guide rods are disposed on the cross brace of the tripod and having one ends provided with fixed bars that are fixed on a side wall of the back plate by screws, the T-shaped guide rod is sleeved with a return spring outside and is connected with a base plate having a hollow structure. Water outlet tubes are disposed at a side of the base plate contacting the back plate. A stroke conversion mechanism is disposed between the base plate and the cross brace. The present invention relates to fitness equipment, the inversion table can effectively improve the air permeability of the back plate as well as safety, to ensure the experience of the exerciser.

### FIELD OF TECHNOLOGY

The present invention relates to the technical field of fitness equipment, in particular to a novel structural inversion table.

### BACKGROUND

With the popularization of digital sports in all walks of life, students, office workers and other groups gradually join the ranks of fitness.

There is a common fitness equipment-inversion table. By using this machine to assist the human body to stand upside down, the blood of the human body flows into the brain in reverse. You only need to use it for 5-10 minutes every day, which is equivalent to supplementing sleep for 2 hours. Therefore, an inversion table is sought after by the majority of fitness enthusiasts. In today's inversion table, a back plate is a whole plate and wrapped with a cushion pad. After fitness, sweat adheres to the back plate because the back is not ventilated, which brings trouble to the post-exercisers.

Therefore, we propose a novel structured inversion table to solve the above problems.

### SUMMARY

The present invention aims at solving the problems existing in the prior art, and provides a novel structural inversion table.

In order to achieve the above purpose, the present invention adopts the following technical solution:

a novel structural inversion table including a body, wherein the body includes a back plate, a headrest and a tripod, and a middle position of the tripod is rotationally connected with a cross brace, a plurality of air holes are penetrated through the back plate, two T-shaped guide rods are disposed on the cross brace of the tripod in a sliding and penetrating manner, and one ends of the two T-shaped guide rods are provided with fixed bars, the fixed bars are fixed on a side wall of the back plate by screws, the T-shaped guide rod is sleeved with a return spring outside, the T-shaped guide rod is connected with a base plate in a sealing and sliding mode, and the base plate is of a hollow structure, a plurality of water outlet tubes positioned to match the air holes are disposed at a side of the base plate being in contacted with the back plate, a stroke conversion mechanism is disposed between the base plate and the cross brace, for gradually forming a separation state between the base plate and the back plate when the back plate is pressed down; the headrest is of a hollow structure, and the headrest is connected to the back plate by a hose.

Preferably, the stroke conversion mechanism includes a fixed rack, a gear, a fixed rod, a fixed sleeve and a movable rack, the fixed rack is vertically disposed on the cross brace, a side wall of the T-shaped guide rod is rotationally connected with the gear, a side wall of the base plate is vertically provided with the fixed rod, the fixed rod is fixedly provided with a plurality of fixed sleeves, a side wall of the fixed sleeve is fixedly connected with the movable rack, and the movable rack, the gear and the fixed rack are meshed.

Preferably, a press valve is disposed between the base plate and the hose.

Preferably, an upper side wall of the headrest is further provided with a liquid injection port, and the liquid injection port is provided with a one-way valve.

Preferably, a periphery of the back plate is provided in an arc shape.

Preferably, the tripod includes a rear bracket, a front bracket, a floor bracket, a foot sleeve and a screw hole, the rear bracket and the front bracket are of hollow structures, and lower ends of the rear bracket and the front bracket are connected with a floor bracket in a sliding mode, two screw holes distributed vertically are disposed on side walls of the rear bracket, the front bracket and the floor bracket and are locked and fixed by screws, the foot sleeves are sleeved at both ends of the floor bracket.

Preferably, the back plate is detachably provided with a lumbar support.

Preferably, both sides of the lumbar support are provided with extensions, and outer ends of two extensions are provided with pasting parts being pasted with the back plate.

Compared with the prior art, the present invention has the advantages that:

1. The present invention is provided with a back plate, air holes and a stroke conversion mechanism, when the back plate is pressed down to drive the T-shaped guide rod to press down and move, with a joint action of the gear, the fixed rack and the movable rack, the back plate and the base plate move in multiples, so that the two are separated to enable the air holes of the back plate to be conducted, thereby improving the air permeability of the back plate when in use; and

2. In the present invention, by providing connecting parts such as a headrest, a base plate, a hose and the like, when finished using the inversion table, the headrest and the base plate are connected by pressing the press valve, and the disinfectant is squeezed and sprayed from the water outlet tubes with the gravity, so that the disinfectant can be sprayed quickly on the surface of the back plate, and the safety of subsequent use is improved.

### BRIEF DESCRIPTION OF THE DRAWINGS

FIG. 1 is a schematic diagram of an overall structure of a novel structural inversion table provided by the present invention;

FIG. 2 is a schematic diagram of a partially exploded structure of the novel structural inversion table provided by the present invention;

FIG. 3 is a structural schematic diagram of connection relationship between a back plate and a cross brace of the novel structural inversion table provided by the present invention;

FIG. 4 is a schematic diagram of a partially exploded structure of the novel structural inversion table provided by the present invention;

FIG. 5 is an enlarged structural diagram at a part A in FIG. 3;

FIG. 6 is a structural schematic diagram of adding a lumbar support in the present invention.

In the drawings: 1. body; 2. back plate; 201. air hole; 3. hose; 301. press valve; 4. headrest; 5. tripod; 501. rear bracket; 502. front bracket; 503. floor bracket; 504. foot sleeve; 505. screw hole; 6. base plate; 7. T-shaped guide rod; 8. return spring; 9. fixed rack; 10. gear; 11. fixed rod; 12. fixed sleeve; 13. movable rack; 14. fixed bar; 15. water outlet tube, 16. threaded hole; 17. screw; 18, through hole; 31. lumbar support; 32. extension; 33. pasting part.

### DESCRIPTION OF THE EMBODIMENTS

A clear and complete description of the technical solution in the embodiments of the present invention will be made below in conjunction with the drawings in the embodiments of the present invention are present. Obviously, the described embodiments are only part of the embodiments of the present invention, but not all of them.

In the description of the present invention, it should be understood that, orientation or positional relationships indicated by terms such as “up”, “down”, “front”, “rear”, “left”, “right”, “top”, “bottom”, “inner”, “outer” are based on the orientation or positional relationships shown in the drawings, for ease of description of the present invention and simplification of the description only, these terms do not indicate or imply that the apparatus or element referred to must have a specific orientation or be constructed and operated in a specific orientation, and therefore cannot be construed as limitations to the present invention.

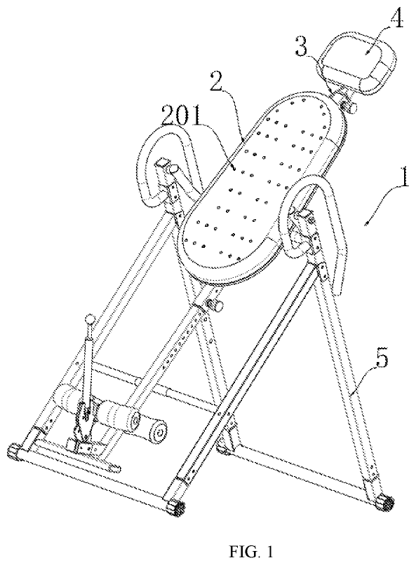

Referring to FIGS. 1-5, a novel structural inversion table includes a body 1, the body 1 includes a back plate 2, a headrest 4 and a tripod 5, and a middle position of the tripod 5 is rotationally connected with a cross brace, wherein the cross brace is a square hollow tube. The tripod 5 includes a rear bracket 501, a front bracket 502, a floor bracket 503, a foot sleeve 504, and a screw hole 505. The rear bracket 501 and the front bracket 502 are both of hollow structures, and lower ends of the rear bracket 501 and the front bracket 502 are connected with a floor bracket 503 in a sliding mode. Two screw holes 505 distributed vertically are disposed on side walls of the rear bracket 501, the front bracket 502 and the floor bracket 503 and are locked and fixed by screws, the foot sleeves 504 are sleeved at both ends of the floor bracket. It should be noted that, the rear bracket 501, the front bracket 502, the floor bracket 503 and the cross brace in the tripod 5 are all connected and fixed by bolts, so that each part can be disassembled and assembled freely, which is convenient for production while increasing the container loading capacity. In addition, the foot sleeves 504 are sleeved on both ends of the floor bracket 503. The foot sleeve is made of rubber material, which can effectively prevent the inversion table from slipping during exercise. The foot sleeves are adjustable, when the ground is not level, the foot sleeves can be adjusted to make the whole machine not shake. A plurality of air holes 201 are penetrated through the back plate 2, two T-shaped guide rods 7 are disposed on the cross brace of the tripod 5 in a sliding and penetrating manner, and one ends of the two T-shaped guide rods 7 are provided with fixed bars 14, the fixed bars 14 are fixed on a side wall of the back plate 2 by screws, the T-shaped guide rod 7 is sleeved with a return spring 8 outside, the T-shaped guide rod 7 is connected with a base plate 6 in a sealing and sliding mode, and the base plate 6 is of a hollow structure, a plurality of water outlet tubes 15 positioned to match the air holes 201 are disposed at a side of the base plate 6 being in contacted with the back plate 2, a stroke conversion mechanism is disposed between the base plate 6 and the cross brace, for gradually forming a separation state between the base plate 6 and the back plate 2 when the back plate 2 is pressed down, the headrest 4 is of a hollow structure, and the headrest 4 is connected to the back plate 6 by a hose 3.

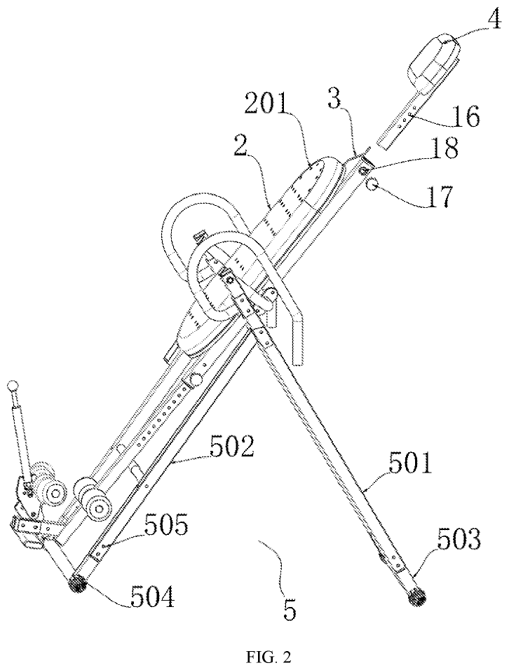

Referring to FIG. 2, specifically, a plurality of threaded holes 16 are provided at equal intervals on a side wall of an insertion rod of the headrest 4, a through hole 18 is provided on a side wall of the cross brace, the headrest 4 is slidingly inserted in the cross brace and locked and fixed by the screw 17, wherein the number of threaded holes 16 is 4, a height of the headrest 4 can be adjusted by sliding the headrest 4, and the screw 17 is inserted into the through hole 18 and is fixedly connected with the threaded hole 16 on the side wall of the insertion rod of the headrest 4 by threading, wherein one end of the screw 17 is provided with a knob, which is convenient for the exerciser to use. In addition, the headrest 4 can be pulled out and separated from the whole structure during use, which is convenient for loading and transporting in cabinets,

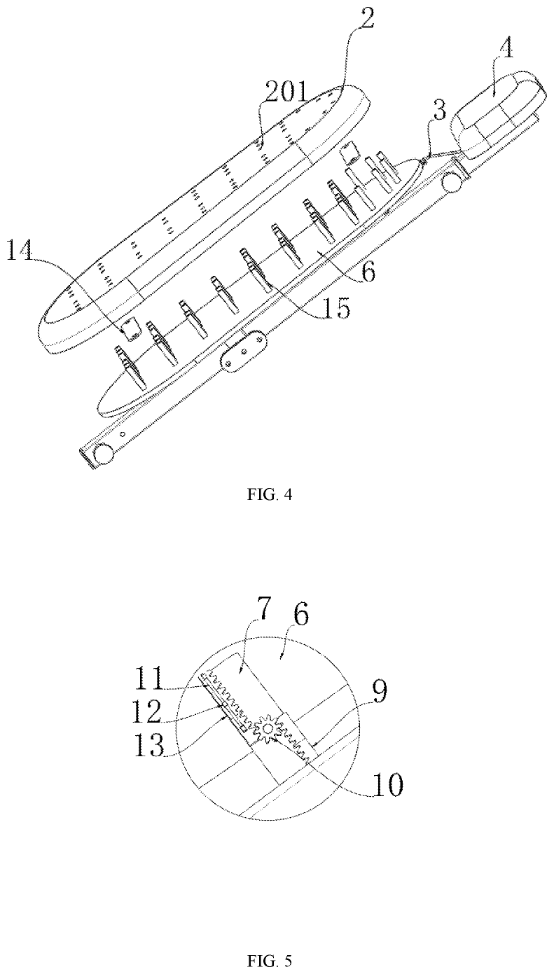

Referring to FIGS. 4-5, specifically, the stroke conversion mechanism includes a fixed rack 9, a gear 10, a fixed rod 11, a fixed sleeve 12 and a movable rack 13, the fixed rack 9 is vertically disposed on the cross brace, a side wall of the T-shaped guide rod 7 is rotationally connected with the gear 10, a side wall of the base plate 6 is vertically provided with the fixed rod 11, the fixed rod 11 is fixedly provided with a plurality of fixed sleeves 12, a side wall of the fixed sleeve 12 is fixedly connected with the movable rack 13, and the movable rack 13, the gear 10 and the fixed rack 9 are meshed.

During the use of the inversion table, when the back of the exerciser rests on the back plate 2, due to the gravity of the body, the back plate 2 is pressed down to move obliquely downward, the return spring 8 is squeezed, the T-shaped guide rod 7 moves along the cross brace, when the gear 10 on one of the T-shaped guide rods 7 moves down and simultaneously is meshed with a fixed rack 9 to rotate. In addition, the gear 10 is meshed with the movable rack 13 at the same time. Due to the mechanical transmission relationship of the gear 10 and the movable rack 13, the T-shaped guide rod 7 moves twice the distance, and the movable rack 13 drives the base plate 6 to move down twice the distance. At this time, the water outlet tube 15 moves out of the air hole 201, and the whole back plate 2 is in a hollow state, so that the back plate 2 attached by a person is ventilated, thereby improving the comfort of fitness and preventing stuffy sweat.

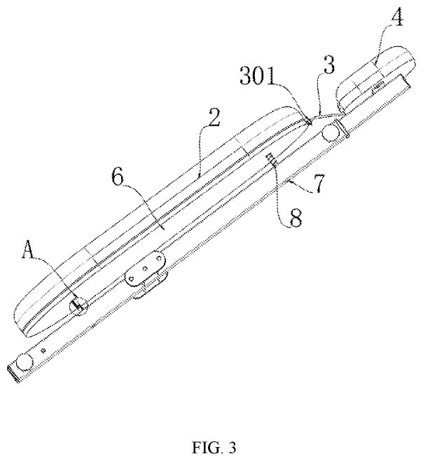

Referring to FIG. 3, specifically, a press valve 301 is provided between the base plate 6 and the hose 3.

When the post-exercisers need to use the inversion table, at this time, the back plate 2 and the base plate 6 of the inversion table are reset with the return spring 8, the press valve 301 can then be pressed to enable the headrest 4 to be connected to the base plate 6, at this time, because the disinfectant is squeezed by gravity and sprayed from each water outlet tube 15, the disinfectant can be quickly sprayed on the surface of the back plate 2, to avoid the need of the exerciser for carrying a disinfectant spraying bottle for spraying, and at the same time, the air permeability and disinfection of the back plate 2 are effectively combined to improve the comfort and safety of the exerciser.

It should be noted that under a normal state of the inversion table, on the one hand, the press valve 301 is closed, and on the other hand, the outlet tube 15 is a slender tube, which effectively prevents the disinfectant from spraying without gravity.

Referring to FIG. 3, specifically, an upper side wall of the headrest 4 is further provided with a liquid injection port, and the liquid injection port is provided with a one-way valve.

The disinfectant can be added inside the headrest 4 in real time, and the one-way valve is set to prevent the disinfectant from countercurrent.

Referring to FIGS. 1-4, specifically, a periphery of the back plate 2 is provided in an arc shape.

The disinfectant sprayed on the back plate 2 can flow down smoothly without accumulating on the back plate 2.

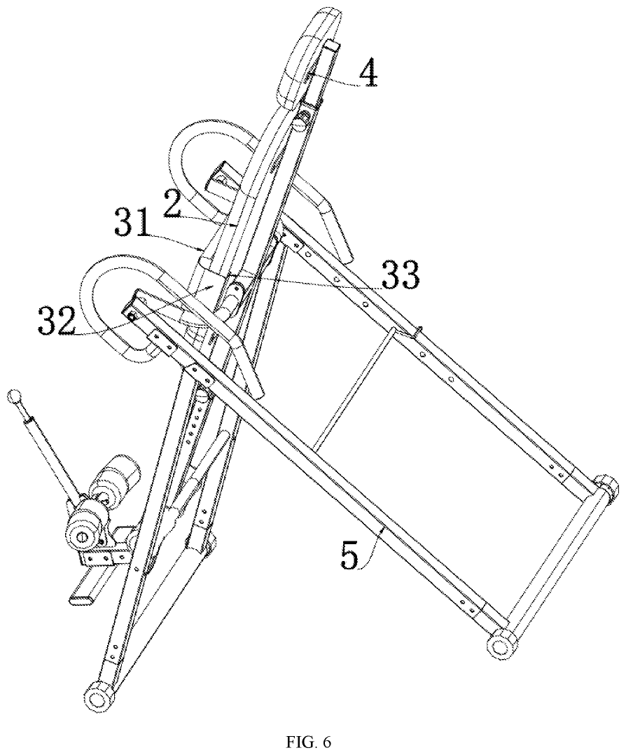

Referring to FIG. 6, specifically, the back plate 2 is detachably provided with a lumbar support 31. The lumbar support 31 can play a role of supporting the lumbar, and functions such as massage and heating can be added in the lumbar support 31.

Specifically, both sides of the lumbar support 31 are provided with extensions 32, and outer ends of two extensions 32 are provided with pasting parts 33 being pasted with the back plate 2. The pasting part 33 is provided with a hook or a loop, and the hook or the loop is bonded with the hook or the loop provided on the back plate 2 to realize the installation of the lumbar support 33.

The above is only a preferred embodiment of the present invention, but the scope of protection of the present invention is not limited thereto. Any equivalent substitution or change made by a person familiar with this technical field according to the technical solution and the technical concept of the present invention within the technical scope disclosed by the present invention should be covered within the scope of protection of the present invention.

What is claimed is:

1. A novel structural inversion table comprising a body including a back plate, a headrest and a tripod, and a middle position of the tripod being rotationally connected with a cross brace, wherein a plurality of air holes are penetrated through the back plate, two T-shaped guide rods are disposed on the cross brace of the tripod in a sliding and penetrating manner, and one ends of the two T-shaped guide rods are provided with fixed bars, the fixed bars are fixed on a side wall of the back plate by screws, the T-shaped guide rod is sleeved with a return spring outside, the T-shaped guide rod is connected with a base plate in a sealing and sliding mode, and the base plate is of a hollow structure, a plurality of water outlet tubes positioned to match the air holes are disposed at a side of the base plate being in contacted with the back plate, a stroke conversion mechanism is disposed between the base plate and the cross brace, for gradually forming a separation state between the base plate and the back plate when the back plate is pressed down; the headrest is of a hollow structure, and the headrest is connected to the back plate by a hose.

2. The novel structural inversion table according to claim 1, wherein the stroke conversion mechanism includes a fixed rack, a gear, a fixed rod, a fixed sleeve and a movable rack, the fixed rack is vertically disposed on the cross brace, a side wall of the T-shaped guide rod is rotationally connected with the gear, a side wall of the base plate is vertically provided with the fixed rod, the fixed rod is fixedly provided with a plurality of fixed sleeves, a side wall of the fixed sleeve is fixedly connected with the movable rack, and the movable rack, the gear and the fixed rack are meshed.

3. The novel structural inversion table according to claim 1, wherein a press valve is disposed between the base plate and the hose.

4. The novel structural inversion table according to claim 1, wherein an upper side wall of the headrest is further provided with a liquid injection port, and the liquid injection port is provided with a one-way valve.

5. The novel structural inversion table according to claim 1, wherein a periphery of the back plate is provided in an arc shape.

6. The novel structural inversion table according to claim 1, wherein a plurality of threaded holes are provided at equal intervals on a side wall of an insertion rod of the headrest, a through hole is provided on a side wall of the cross brace, the headrest is slidingly inserted in the cross brace and locked and fixed by the screw.

7. The novel structural inversion table according to claim 1, wherein the tripod includes a rear bracket, a front bracket, a floor bracket, a foot sleeve, and a screw hole, the rear bracket and the front bracket are both of hollow structures, and lower ends of the rear bracket and the front bracket are connected with a floor bracket in a sliding mode, two screw holes distributed vertically are disposed on side walls of the rear bracket, the front bracket and the floor bracket and are locked and fixed by screws, the foot sleeves are sleeved at both ends of the floor bracket.

8. The novel structural inversion table according to claim 1, wherein the back plate is detachably provided with a lumbar support.

9. The novel structural inversion table according to claim 8, wherein both sides of the lumbar support are provided with extensions, and outer ends of two extensions are provided with pasting parts being pasted with the back plate.
